(19) United States
(12) Patent Application Publication
(10) Pub. No.: US 2017/0304904 A1
(43) Pub. Date: Oct. 26, 2017

(54) BORING DEVICE

(71) Applicant: DENSO CORPORATION, Kariya-city, Aichi-pref. (JP)

(72) Inventor: Noritsugu KATO, Kariya-city (JP)

(21) Appl. No.: 15/520,229

(22) PCT Filed: Jan. 15, 2016
(86) PCT No.: PCT/JP2016/000171

§ 371 Date: Apr. 19, 2017

(30) Foreign Application Priority Data
Jan. 22, 2015 (JP) 2015-010282

(51) Int. Cl. B23B 29/034; B23B 51/04; B23B 29/00; B23B 51/00

(52) U.S. Cl. CPC B23B 29/034; B23B 51/0493; B23B 29/00; B23B 51/00; B23B 2251/422

(57) ABSTRACT

A boring device includes: a rotatable body, which has a workpiece holder, a valve seat receiver and a debris passage portion; a laser emitter; a pump and a control unit. The workpiece holder can hold a nozzle body. The valve seat receiver contacts a valve seat of the nozzle body that is held by the workpiece holder. The laser emitter emits a laser beam to an outer wall of the nozzle body to bore injection holes at the nozzle body. The debris passage portion includes a debris passage that is placed on a radially inner side of the valve seat receiver and guides debris formed at the time of boring the injection holes with the laser beam. The pump vacuums the debris through the debris passage. The control unit controls a laser output power of the laser emitter and a suction force of the pump.

### CROSS REFERENCE TO RELATED APPLICATION

This application is based on and incorporates herein by reference Japanese Patent Application No. 2015-10282 filed on Jan. 22, 2015.

### TECHNICAL FIELD

The present disclosure relates to a boring device for a nozzle body.

### BACKGROUND ART

There is known a boring device that bores an injection hole at a nozzle body through use of a laser beam. For example, a boring device disclosed in the patent literature 1 includes an inserting member that is inserted into an inside of the nozzle body. A distal end part of the inserting member has a core body that receives the laser beam, which has passed through the injection hole. The core body has a communication hole that conducts debris, which is generated at a time of boring the injection hole at the nozzle body. The debris is metal evaporated by a light energy at the time of executing the laser processing. The debris is sucked with the pump through the communication hole.

In the patent literature 1, a space, which is formed between an outer wall of the inserting member and an inner wall of the nozzle body, is used as a debris suction passage. This debris suction passage includes a space (a valve seat adjoining space) located between an outer wall of the core body and a valve seat of the nozzle body. An outlet of the communication hole of the core body is communicated with the valve seat adjoining space.

Furthermore, in the patent literature 1, the laser processing is executed in a state where a gap is present between the outer wall of the core body and a sac chamber inner wall of the nozzle body. A space, into which the debris is discharged from the injection hole, is communicated with the valve seat adjoining space through the above-described gap. Therefore, even in a case where the above-described gap is smaller than the communication hole, a flow, which is directed from the injection hole to the valve seat adjoining space through the above-described gap, is generated.

Thus, in the boring device disclosed in the patent literature 1, there is a possibility of that the debris adheres to the valve seat of the nozzle body.

### CITATION LIST

### Patent Literature

PATENT LITERATURE 1: JP5518680B2

### SUMMARY OF THE INVENTION

The present disclosure is made in view of the above point, and it is an objective of the present disclosure to provide a boring device that can limit adhesion of debris to a valve seat of a nozzle body.

A boring device of the present disclosure includes a workpiece holder, a valve seat receiver, a laser emitting device, a debris passage portion, a suction device and a control device. The workpiece holder holds the nozzle body at a time of boring an injection hole at the nozzle body. The valve seat receiver contacts a valve seat of the nozzle body, which is held by the workpiece holder. The laser emitting device emits a laser beam to the nozzle body, which is held by the workpiece holder, from a side where an outer wall of the nozzle body is located, to bore the injection hole. The debris passage portion is located on a radially inner side of the valve seat receiver. The debris passage portion includes a debris passage that conducts debris, which is generated at the time of boring the injection hole. The suction device suctions the debris through the debris passage. The control device controls a laser output power of the laser emitting device and a suction force of the suction device.

By forming the valve seat receiver, which contacts the valve seat, the valve seat is protected by the valve seat receiver from the debris. Specifically, the debris, which is discharged into the inside of the nozzle body at the moment of penetration of the injection hole through the nozzle body, is sucked through the debris passage without contacting the valve seat. Thus, according to the present disclosure, it is possible to limit adhesion of the debris to the valve seat.

### BRIEF DESCRIPTION OF DRAWINGS

FIG. 1 is a cross-sectional view of a fuel injection valve that has a nozzle body processed with a boring device according to a first embodiment of the present disclosure.

FIG. 2 is an enlarged view of an area around the nozzle body shown in FIG. 1.

FIG. 3 is a schematic diagram showing an entire structure of the boring device according to the first embodiment of the present disclosure.

FIG. 4 is an enlarged view showing an area around a rotatable body of the boring device shown in FIG. 3.

FIG. 5 is an enlarged view of an area V in FIG. 4.

FIG. 6 is a flowchart for describing a process executed by a control unit shown in FIG. 3.

FIG. 7 is a timing chart indicating a change in a flow velocity at a measurement chamber, a change in a suction force of a pump, and a change in a laser output power of a laser emitter with time in FIG. 3.

FIG. 8 is an enlarged view around a workpiece holder of a boring device according to a second embodiment of the present disclosure.

FIG. 9 is an enlarged view around a workpiece holder of a boring device according to a third embodiment of the present disclosure.

FIG. 10 is an enlarged view around a workpiece holder of a boring device according to a fourth embodiment of the present disclosure.

FIG. 11 is a schematic diagram showing an entire structure of a boring device according to a fifth embodiment of the present disclosure.

FIG. 12 is a schematic diagram showing an entire structure of a boring device according to a sixth embodiment of the present disclosure.

FIG. 13 is an enlarged view around a workpiece holder of a boring device according to a seventh embodiment of the present disclosure.

FIG. 14 is a cross-sectional view taken along line XIV-XIV in FIG. 13.

FIG. 15 is an enlarged view around a workpiece holder of a boring device according to an eighth embodiment of the present disclosure.

FIG. 16 is an enlarged view around a rotatable body of a boring device according to a ninth embodiment of the present disclosure.

FIG. 17 is an enlarged view of an area XVII in FIG. 16.

FIG. 18 is a cross-sectional view taken along line XVIII-XVIII in FIG. 17.

FIG. 19 is an enlarged view around a workpiece holder of a boring device according to a tenth embodiment of the present disclosure.

FIG. 20 is a schematic diagram showing an entire structure of a boring device according to a reference embodiment.

### DESCRIPTION OF EMBODIMENTS

Hereinafter, various embodiments of the present disclosure will be described with reference to the drawings. The same structures, which are identical to each other between corresponding ones of the embodiments, will be indicated by the same reference signs and will not be described redundantly for the sake of simplicity.

### First Embodiment

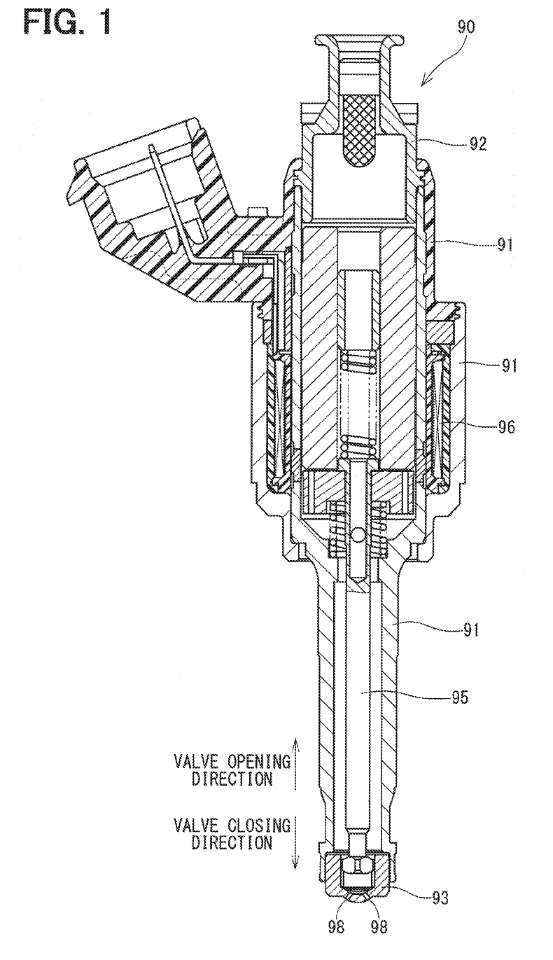

A boring device according to a first embodiment of the present disclosure is used for processing a nozzle body 93 of a fuel injection valve 90 shown in FIG. 1.

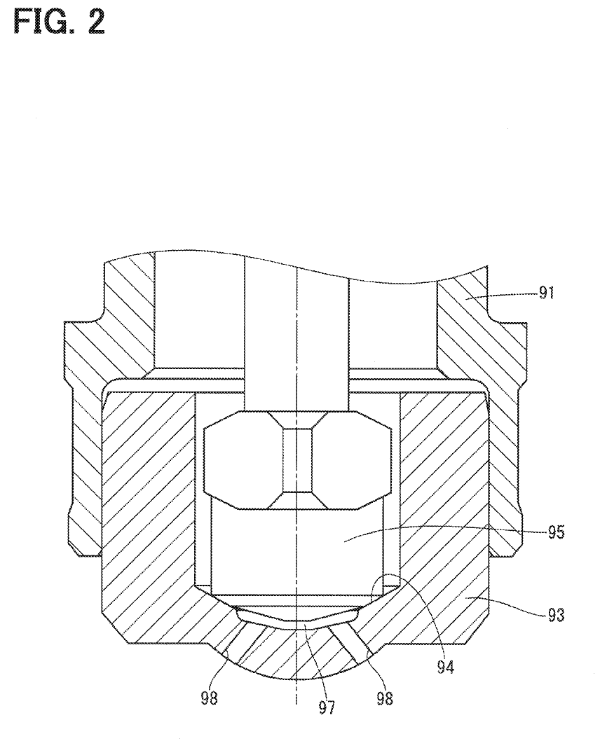

As shown in FIGS. 1 and 2, the fuel injection valve 90 includes: a housing 91; a fuel inlet pipe 92, which is installed at one end part of the housing 91; the nozzle body 93, which is installed at the other end part of the housing 91; a needle 95, which is movable toward and away from a valve seat 94 formed in an inner wall of the nozzle body 93; and a drive device 96, which is operable to drive the needle 95 in an axial direction.

A sac chamber 97 is formed between the needle 95, which is seated against the valve seat 94, and the nozzle body 93. The nozzle body 93 includes a plurality of injection holes 98 that extend from an outer wall surface to an inner wall surface of the nozzle body 93 and is communicated with the sac chamber 97. The fuel, which is introduced into the housing 91 through the fuel inlet pipe 92, is supplied to the sac chamber 97 and is then injected through the injection holes 98 when the needle 95 is lifted away from the valve seat 94. The injection holes 98 are bored with the boring device 10.

### (Basic Structure)

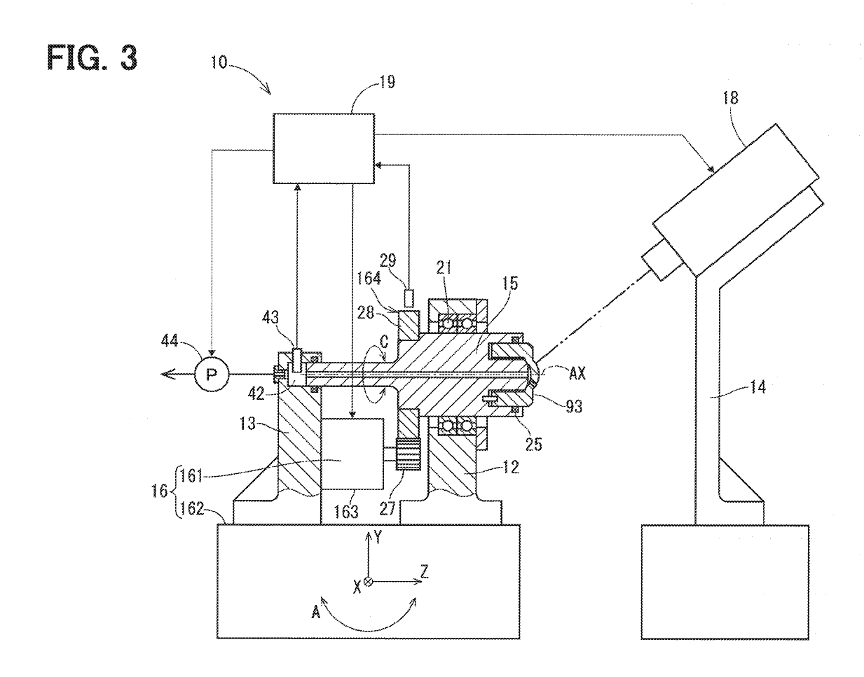

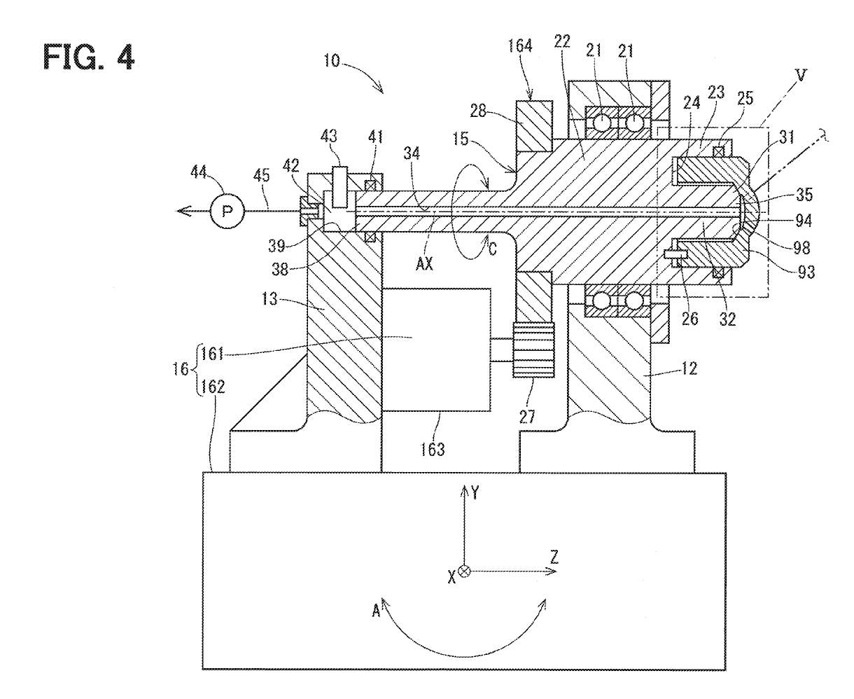

First of all, a basic structure of the boring device will be described with reference to FIGS. 3 and 4.

As shown in FIGS. 3 and 4, the boring device 10 includes a first support body 12, a second support body 13, a third support body 14, a rotatable body 15, a drive device 16, a laser emitter (serving as a laser emitting device) 18, and a control unit (serving as a control device) 19.

The rotatable body 15 forms a supportable portion 22, which is rotatably supported by the first support body 12 through a bearing 21, and a workpiece holder 23, which is shaped into a tubular form and projects from the supportable portion 22 in the axial direction. The workpiece holder 23 includes a fitting hole 24, which has a bottom and into which the nozzle body 93 is fittable. The workpiece holder 23 can hold the nozzle body 93.

A seal member 25 is installed in a tubular portion of the fitting hole 24. The seal member 25 seals a gap between the tubular portion of the fitting hole 24 and the nozzle body 93. Furthermore, a positioning pin 26 is installed in a bottom portion of the fitting hole 24. The positioning pin 26 is engaged with the nozzle body 93 to limit relative rotation between the workpiece holder 23 and the nozzle body 93.

The drive device 16 includes a first drive device 161 and a second drive device 162.

The first drive device 161 includes a motor 163 and a speed reducing device 164. The motor 163 is fixed to the second support body 13. The speed reducing device 164 includes a drive gear 27, which is fixed to an output shaft of the motor 163, and a driven gear 28, which is fixed to the rotatable body 15 and is meshed with the drive gear 27. A rotational speed of rotation of the motor 163 is reduced by the speed reducing device 164, and the rotation of the reduced rotational speed is transmitted from the speed reducing device 164 to the rotatable body 15. The first drive device 161 can rotate the rotatable body 15 about an axis AX, as indicated by an arrow C in FIG. 3.

The second drive device 162 can move the first support body 12, the second support body 13 and members (including the rotatable body 15), which are fixed to or supported by the first support body 12 and the second support body 13, in three directions that are perpendicular to each other as indicated by arrows X, Y, Z in FIG. 3. Furthermore, the second drive device 162 is rotatable about an axis that is parallel to the X direction, as indicated by an arrow A in FIG. 3.

The laser emitter 18 includes, for example, a laser oscillator and a lens, which are not depicted in the drawings. The laser emitter 18 is fixed to the third support body 14. The laser emitter 18 is operable to emit a laser beam to the outer wall of the nozzle body 93, which is held by the workpiece holder 23, to bore the injection holes 98 at the nozzle body 93.

The control unit 19 includes a microcomputer as a main component thereof and controls the laser emitter 18 and the drive device 16. Specifically, the control unit 19 controls a laser output power and a laser emitting time period of the laser emitter 18. Furthermore, the control unit 19 operates the drive device 16 during a time interval between one laser emission and another laser emission based on a position of the rotatable body 15, which is sensed with the rotational position sensor 29 and a position sensor (not shown), to coincide an opening position, at which the injection hole 98 is bored, and an illuminating area of the laser beam with each other.

### (Characteristic Structure)

Next, a characteristic structure of the boring device 10 will be described with reference to FIGS. 3 to 6.

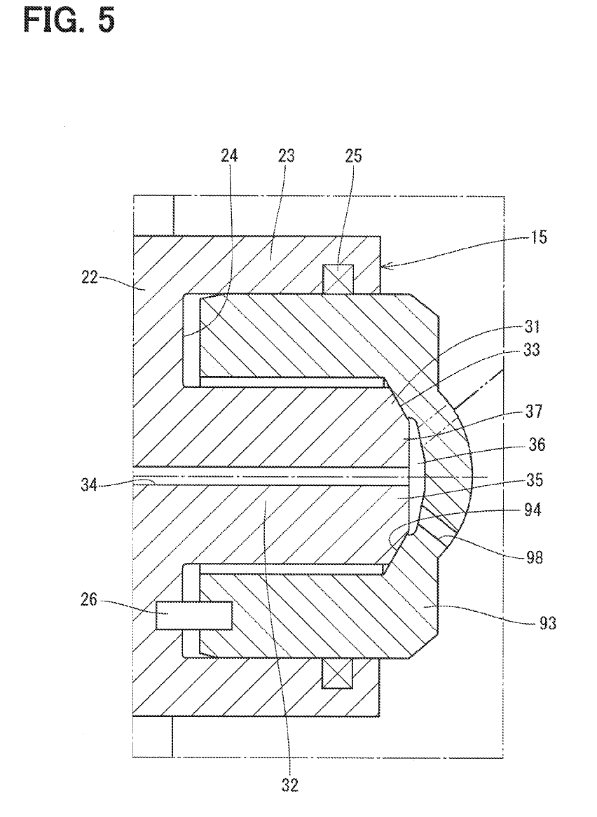

As shown in FIGS. 4 and 5, the rotatable body 15 forms a valve seat receiver 31 and a debris passage portion 32.

As shown in FIG. 5, the valve seat receiver 31 is shaped into a tubular form such that the valve seat receiver 31 projects from the bottom portion of the fitting hole 24 in the axial direction. The valve seat receiver 31 includes a valve seat receiving surface 33, which is in a form of a tapered surface and contacts the valve seat 94 of the nozzle body 93, which is held by the workpiece holder 23. In the present embodiment, at the time of holding the nozzle body 93 with the workpiece holder 23, the nozzle body 93 is urged toward the bottom portion of the fitting hole 24 by a clamp (not shown). In this way, the valve seat receiving surface 33 tightly contacts an entire surface of the valve seat 94.

The debris passage portion 32 includes a debris passage 34. The debris passage 34 is placed on a radially inner side of the valve seat receiver 31 and can guide debris formed at the time of boring the injection holes 98 with the laser beam. In the present embodiment, the debris passage portion 32 is formed at a center part of the rotatable body 15. One end part 35 of the debris passage portion 32 forms a debris discharge space 36 at a location between the one end part 35 of the debris passage portion 32 and the nozzle body 93 held with the workpiece holder 23. The debris passage 34 is communicated with the debris discharge space 36. Furthermore, the one end part 35 of the debris passage portion 32 forms a laser receiving part 37 that receives the laser beam, which passes through the injection hole 98 upon penetration of the injection hole 98 through the nozzle body 93, in the inside of the nozzle body 93.

As shown in FIG. 4, the other end part 38 of the debris passage portion 32 is formed to project from the supportable portion 22 in the axial direction and is fitted into a bottomed hole 39 of the second support body 13. The debris passage 34 is formed to penetrate through the center of the rotatable body 15 in the axial direction. A gap between a tubular portion of the bottomed hole 39 and the debris passage portion 32 is sealed with a seal member 41. A measurement chamber 42 is formed between a bottom surface of the bottomed hole 39 and an end surface of the debris passage portion 32. A flow velocity sensor 43 is installed in the measurement chamber 42.

As shown in FIG. 3, the boring device 10 further includes a pump 44, which serves as a suction device. The pump 44 is connected to the measurement chamber 42 through a suction pipe 45. The pump 44 can suck the debris, which is discharged into the debris discharge space 36 at the moment of penetration of the injection hole 98 through the nozzle body 93, via the debris passage 34, the suction pipe 45 and the measurement chamber 42.

The flow velocity sensor 43 and the control unit 19 form a penetration sensing device that senses the penetration of the injection hole 98 through the nozzle body 93. Specifically, the control unit 19 starts the sucking with the pump 44 at the timing of starting the emission of the laser beam from the laser emitter 18. When an increase rate of the flow velocity of the air in the measurement chamber 42, which is sensed with the flow velocity sensor 43, becomes equal to or larger than a predetermined value, the control unit 19 determines that the injection hole 98 penetrates through the nozzle body 93. Hereinafter, the timing of sensing the penetration of the injection hole 98 will be simply referred to as penetration sensing timing.

The control unit 19 controls a laser output power of the laser emitter 18 and a suction force of the pump 44 based on the penetration sensing timing. Specifically, the control unit 19 stops the output of the laser beam from the laser emitter 18 when a predetermined first waiting time period elapses from the penetration sensing timing. The first waiting time period is set to be a sufficient time period that is required to completely remove a peripheral edge part of the injection hole 98 at the inner wall side of the nozzle body 93 from the moment of penetration of the injection hole 98 through the nozzle body 93. Furthermore, the control unit 19 increases the suction force of the pump 44 at the penetration sensing timing. Also, the control unit 19 stops the suctioning with the pump 44 when a predetermined second waiting time period elapses from the penetration sensing timing. The second waiting time period is set to be a sufficient time period that is required to completely remove the debris discharged into the debris discharge space 36 from the moment of penetration of the injection hole 98 through the nozzle body 93.

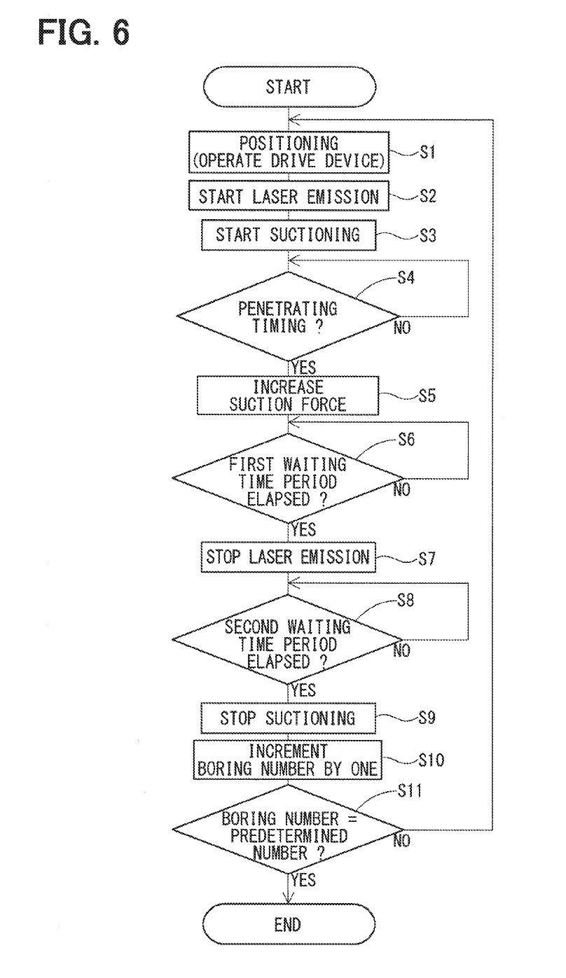

The control unit 19 implements the above-described respective functions by executing an operation shown in FIG. 6. A series of steps described below is executed when a required condition (e.g., completion of setting of the nozzle body 93 to the workpiece holder 23) is satisfied.

When the execution of the operation of FIG. 6 is started, the operation first proceeds to step S1. At step S1, the opening position, at which the injection hole 98 is bored, and the illuminating area of the laser beam are coincided with each other by operating the drive device 16. After step S1, the operation proceeds to step S2.

At step S2, the emitting of the laser beam from the laser emitter 18 is started. After step S2, the operation proceeds to step S3.

At step S3, the suctioning with the pump 44 is started. After step S3, the operation proceeds to step S4.

At step S4, it is determined whether the injection hole 98 has penetrated. In the present embodiment, it is determined that the injection hole 98 has penetrated when the increase rate of the flow velocity in the measurement chamber 42 becomes equal to or larger than the predetermined value. As long as a result of the determination at step S4 is negative (i.e., NO at step S4), step S4 is repeated. In contrast, when the result of the determination at step S4 is positive (i.e., YES at step S4), the operation proceeds to step S5.

At step S5, the suction force of the pump 44 is increased. After step S5, the operation proceeds to step S6.

At step S6, it is determined whether the first waiting time period has elapsed from the penetration sensing timing. As long as a result of the determination at step S6 is negative (i.e., NO at step S6), step S6 is repeated. In contrast, when the result of the determination at step S6 is positive (i.e., YES at step S6), the operation proceeds to step S7.

At step S7, the emitting of the laser beam from the laser emitter 18 is stopped. After step S7, the operation proceeds to step S8.

At step S8, it is determined whether the second waiting time period has elapsed from the penetration sensing timing. As long as a result of the determination at step S8 is negative (i.e., NO at step S8), step S8 is repeated. In contrast, when the result of the determination at step S8 is positive (i.e., YES at step S8), the operation proceeds to step S9.

At step S9, the suctioning with the pump 44 is stopped. After step S9, the operation proceeds to step S10.

At step S10, a counter for counting the boring number (the number of the injection holes 98 bored) is incremented by one. After step S10, the operation proceeds to step S11.

At step S11, it is determined whether the boring number has reached a predetermined number. When a result of the determination at step S11 is negative (i.e., NO at step S11), the operation returns step S1. In contrast, when the result of the determination at step S11 is positive (i.e., YES at step S11), the routine of FIG. 6 is terminated.

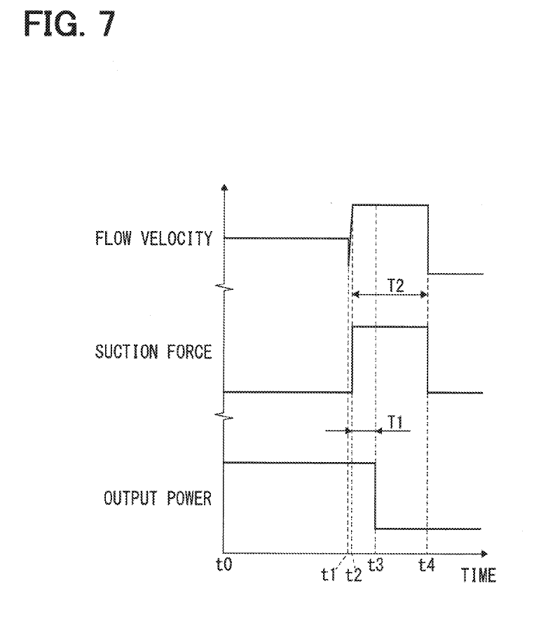

FIG. 7 is a timing chart indicating a change in the flow velocity at the measurement chamber 42, a change in the suction force of the pump 44, and a change in the laser output power of the laser emitter 18 with time. At a time point t0, the emitting of the laser beam from the laser emitter 18 is started, and the suctioning with the pump 44 is started. At a time point t1, the flow velocity is momentarily decreased and is thereafter increased due to the penetration of the injection hole 98. At a time point t2, in response to an increase in the increase rate of the flow velocity, the control unit 19 determines that the injection hole 98 penetrates the nozzle body 93 and, thereby the control unit 19 increases the suction force. At a time point t3 that is a time point upon elapse of the first waiting time period T1 from the time point t2, the emitting of the laser beam from the laser emitter 18 is stopped. At a time point t4 that is a time point upon elapse of the second waiting time period T2 from the time point t2, the suction force of the pump 44 is decreased.

### (Advantages)

As discussed above, according to the first embodiment, the boring device 10 includes: the rotatable body 15, which has the workpiece holder 23, the valve seat receiver 31 and the debris passage portion 32; the laser emitter 18; the pump 44; and the control unit 19. The workpiece holder 23 can hold the nozzle body 93. Specifically, at the time of executing hole boring process for boring the injection holes 98 at the nozzle body 93, the workpiece holder 23 holds the nozzle body 93. The valve seat receiver 31 contacts the valve seat 94 of the nozzle body 93 that is held by the workpiece holder 23. The laser emitter 18 emits the laser beam to the outer wall of the nozzle body 93, which is held by the workpiece holder 23, to bore the injection holes 98 at the nozzle body 93. The debris passage portion 32 includes the debris passage 34. The debris passage 34 is placed on the radially inner side of the valve seat receiver 31 and guides the debris formed at the time of boring the injection holes 98 with the laser beam. The pump 44 sucks the debris through the debris passage 34. The control unit 19 controls the laser output power of the laser emitter 18 and the suction force of the pump 44.

As discussed above, by forming the valve seat receiver 31, which contacts the valve seat 94, the valve seat 94 is protected by the valve seat receiver 31 from the debris. Specifically, the debris, which is discharged into the inside of the nozzle body 93 at the moment of penetration of the injection hole 98 through the nozzle body 93, is sucked through the debris passage 34 without contacting the valve seat 94. Thus, according to the first embodiment, it is possible to limit adhesion of the debris to the valve seat 94.

Furthermore, in the first embodiment, the flow velocity sensor 43 and the control unit 19 are provided as the penetration sensing device that senses the penetration of the injection hole 98 through the nozzle body 93. The control unit 19 controls a laser output power of the laser emitter 18 and a suction force of the pump 44 based on the penetration sensing timing.

Thereby, it is possible to avoid, for example, unnecessary continuation of emitting of the laser beam after the penetration of the injection hole 98, an unnecessary increase of the suction force before the time of penetration of the injection hole 98, and unnecessary continuation of the suctioning after the penetration of the injection hole 98. Thus, it is possible to reduce the electric power consumption.

Furthermore, according to the first embodiment, the control unit 19 stops the output of the laser beam from the laser emitter 18 when the first waiting time period T1 elapses from the penetration sensing timing.

With this construction, the laser emission can be stopped after cleanly processing the peripheral edge part of the injection hole 98, which is located on the sac chamber 97 side.

Furthermore, according to the first embodiment, the control unit 19 starts the suctioning with the pump 44 during the time period, which is from the time of starting the emission of the laser beam from the laser emitter 18 to the time of penetration of the injection hole 98. Furthermore, the control unit 19 increases the suction force of the pump 44 at the penetration sensing timing. Also, the control unit 19 stops the suctioning with the pump 44 when the second waiting time period T2 elapses from the penetration sensing timing.

With the above construction, the debris, which flows into the inside of the nozzle body 93 at the moment of penetration of the injection hole 98, can be effectively removed.

Furthermore, the valve seat receiver 31 includes the valve seat receiving surface 33 that is in the form of the tapered surface and contacts the valve seat 94 of the nozzle body 93, which is held by the workpiece holder 23.

Thus, it is possible to limit the adhesion of the debris to the valve seat 94.

Furthermore, according to the first embodiment, the debris passage portion 32 forms the laser receiving part 37 that receives the laser beam, which passes through the injection hole 98 upon penetration of the injection hole 98 through the nozzle body 93, in the inside of the nozzle body 93.

Thus, it is possible to limit damaging of the inner wall of the nozzle body 93 with the laser beam that has passed through the injection hole 98.

### Second Embodiment

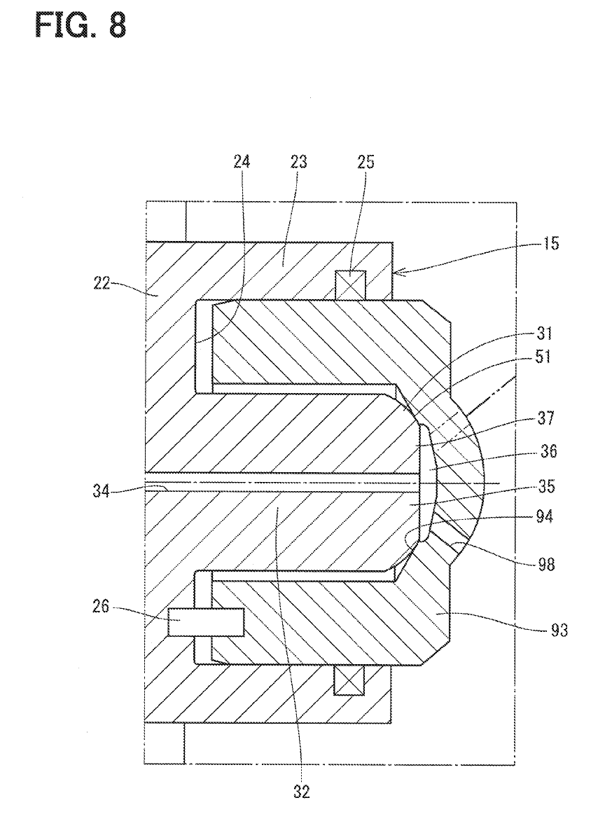

In a second embodiment of the present disclosure, as shown in FIG. 8, the valve seat receiver 31 includes a valve seat receiving surface 51 that is in a form of a protruding curved surface. The valve seat receiving surface 51 contacts a radially inner part of the valve seat 94. Even in this case where the valve seat receiving surface 51 is in the form of the protruding curved surface, the advantages, which are similar to those of the first embodiment, can be achieved.

### Third Embodiment

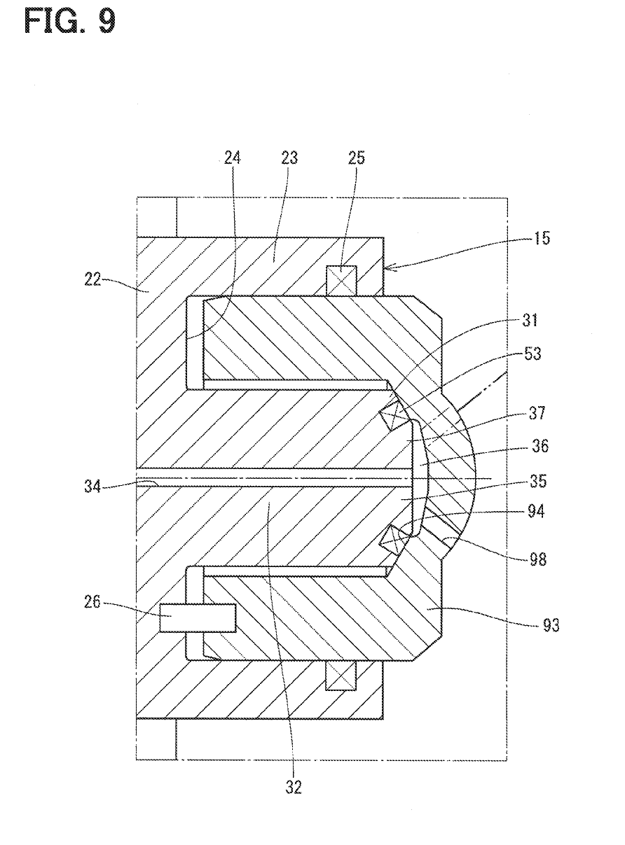

In a third embodiment of the present disclosure, as shown in FIG. 9, there is provided a seal member 53 that serves as a seal portion, which is located between the valve seat 94 of the nozzle body 93 held by the workpiece holder 23 and the valve seat receiver 31. The seal member 53 is, for example, an O-ring. The seal member 53 contacts the radially inner part of the valve seat 94. By providing the seal member 53 between the valve seat 94 and the valve seat receiver 31, it is possible to further limit the adhesion of the debris to the valve seat 94.

### Fourth Embodiment

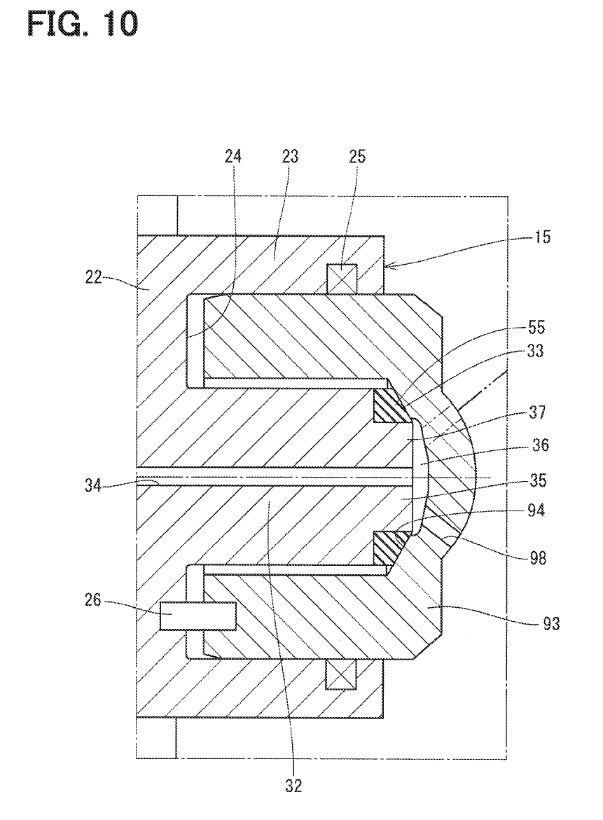

In a fourth embodiment of the present disclosure, as shown in FIG. 10, a material of the valve seat receiving portion 55 is a material, such as rubber, which has elasticity. A material of the laser receiving part 37 is a material, such as zirconia, which is hard to be melted by the laser beam. When at least the portion of the valve seat receiving portion 55, which contacts the valve seat 94, is made of the material that is different from the material of the laser receiving part 37, it is possible to improve the corresponding functions by optimizing the material of each of the portion of the valve seat receiving portion 55 and the laser receiving part 37. A degree of adhesion between the valve seat receiving portion 55 and the valve seat 94 can be improved, and a damage of the laser receiving part 37 caused by the laser beam can be limited.

### Fifth Embodiment

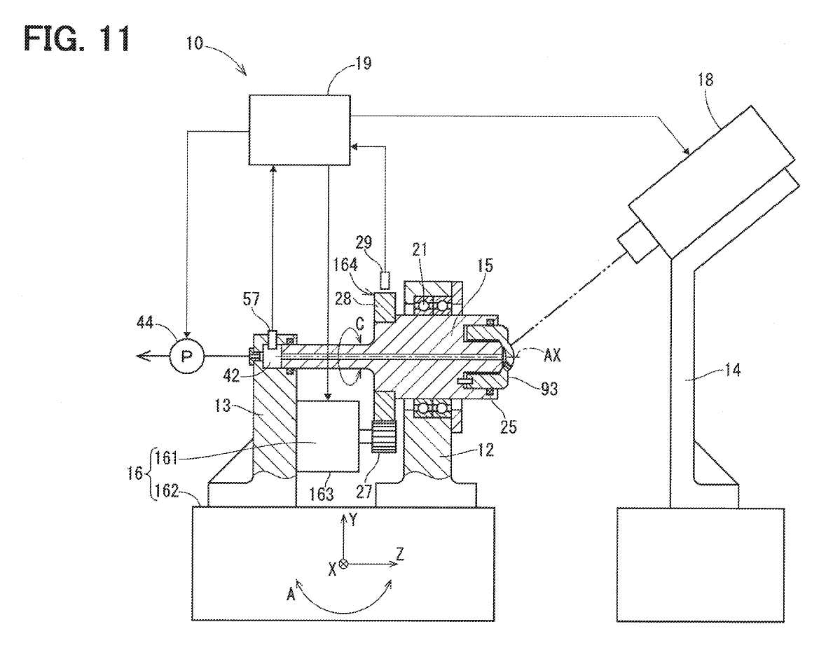

In a fifth embodiment of the present disclosure, as shown in FIG. 11, a pressure sensor 57 is placed in the measurement chamber 42. The pressure sensor 57 is provided in place of the flow velocity sensor 43 of the first embodiment. The pressure sensor 57 and the control unit 19 serve as a penetration sensing device. When an increase rate of a pressure in the measurement chamber 42, which is sensed with the pressure sensor 57, becomes equal to or higher than a predetermined value, the control unit 19 determines that the injection hole 98 penetrates through the nozzle body 93. As described above, even when the pressure sensor 57 is provided in place of the flow velocity sensor 43, the advantages, which are similar to those of the first embodiment, can be achieved.

### Sixth Embodiment

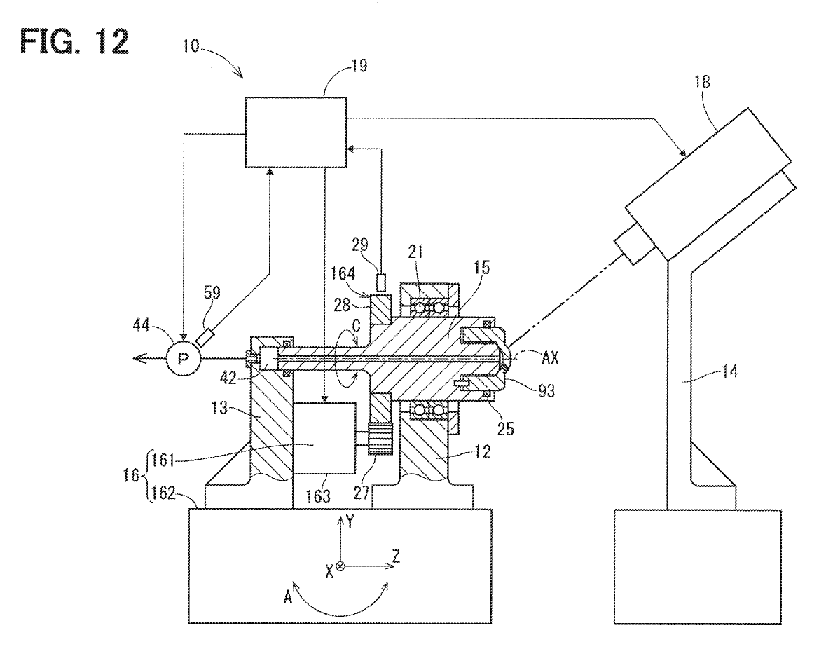

In a sixth embodiment of the present disclosure, as shown in FIG. 12, a pump rotational speed sensor 59, which senses a rotational speed of the pump 44, is provided. The pump rotational speed sensor 59 is provided in place of the flow velocity sensor 43 of the first embodiment. The pump rotational speed sensor 59 and the control unit 19 serve as a penetration sensing device. When an increase rate of the rotational speed of the pump 44, which is sensed with the pump rotational speed sensor 59, becomes equal to or larger than a predetermined value, the control unit 19 determines that the injection hole 98 penetrates through the nozzle body 93. As described above, even when the pump rotational speed sensor 59 is provided in place of the flow velocity sensor 43, the advantages, which are similar to those of the first embodiment, can be achieved.

### Seventh Embodiment

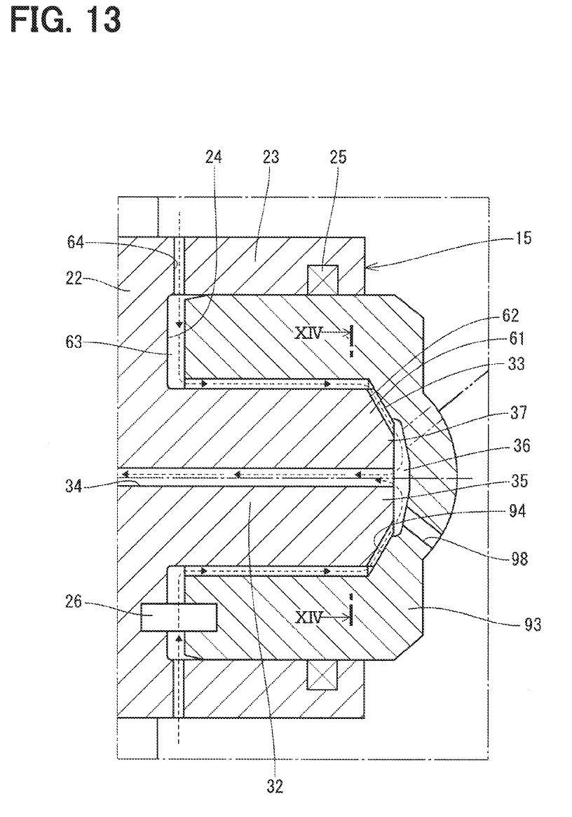

In a seventh embodiment of the present disclosure, as shown in FIG. 13, the valve seat receiver 61 includes outside communication passages 62 that are communicated with the debris discharge space 36 and are also communicated with an external space. Each outside communication passage 62 is communicated with the external space through a gap 63, which is formed between the bottom portion of the fitting hole 24 and the nozzle body 93, and a through-hole 64 of the workpiece holder 23. Since the suctioning with the pump 44 is started before the time of penetration of the injection hole 98, an airflow, which flows from the outside communication passage 62 to the debris passage 34 through the debris discharge space 36, can be generated before the time of penetration of the injection hole 98, as indicated by a dotted arrow in FIG. 13. Therefore, the debris can be effectively removed in such a manner that the debris is carried out by the airflow that has been already generated at the time of penetration of the injection hole 98.

Furthermore, in the seventh embodiment, each outside communication passage 62 is a groove that is formed at an opposing part, which is opposed to the valve seat 94 of the nozzle body 93 held by the workpiece holder 23. Therefore, it is possible to generate the airflow that flows from an outer side to an inner side of the debris discharge space 36 in the radial direction. Thus, the debris can be effectively removed.

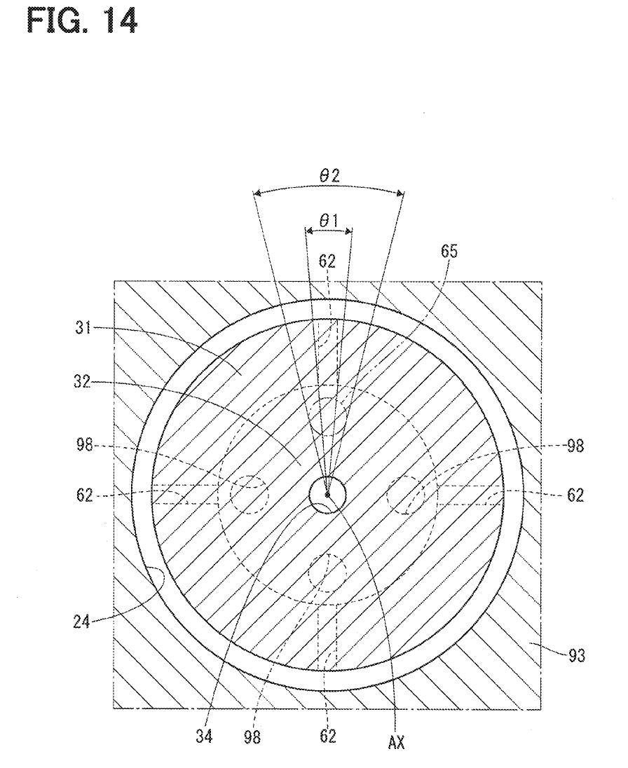

Furthermore, in the seventh embodiment, as shown in FIG. 14, a circumferential angular range θ1, which is occupied by the outside communication passage 62, overlaps with a circumferential angular range 92, which is occupied by the illuminating area 65 of the laser beam emitted from the laser emitter 18. Thus, the airflow, which flows from the outside communication passage 62 to the debris passage 34 through the debris discharge space 36, can be formed around the injection hole 98. Thus, the debris can be effectively removed.

### Eighth Embodiment

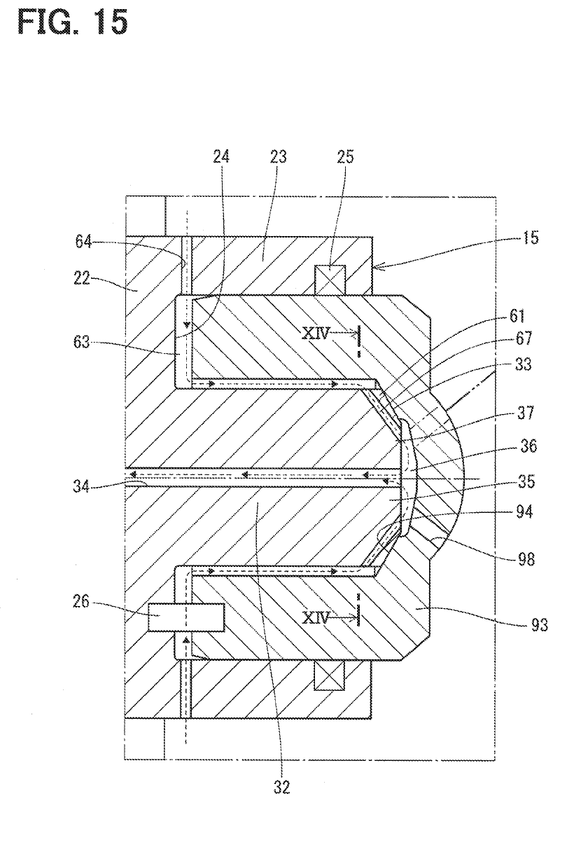

In an eighth embodiment of the present disclosure, as shown in FIG. 15, each of the outside communication passages 67 is in a form of a hole. Even when each outside communication passage 67 is formed as the hole, the airflow, which flows from the outside communication passage 67 to the debris passage 34 through the debris discharge space 36, can be generated before the time of penetration of the injection hole 98, as indicated by a dotted arrow in FIG. 15 like in the seventh embodiment.

### Ninth Embodiment

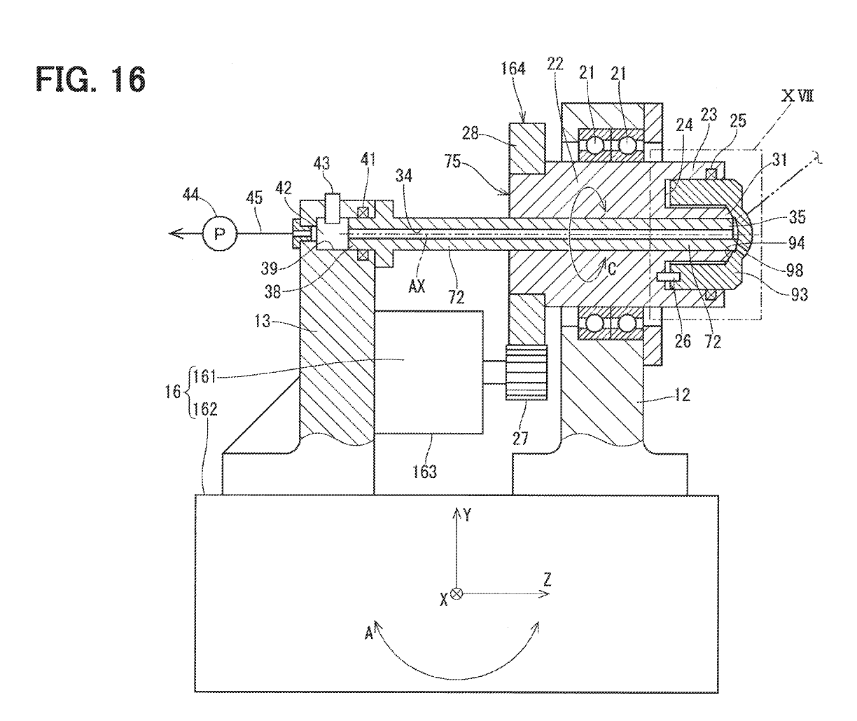

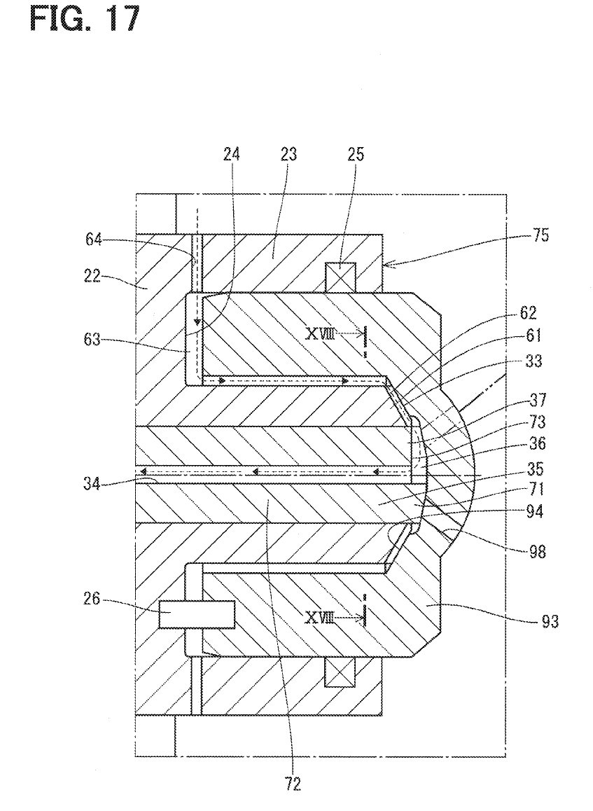

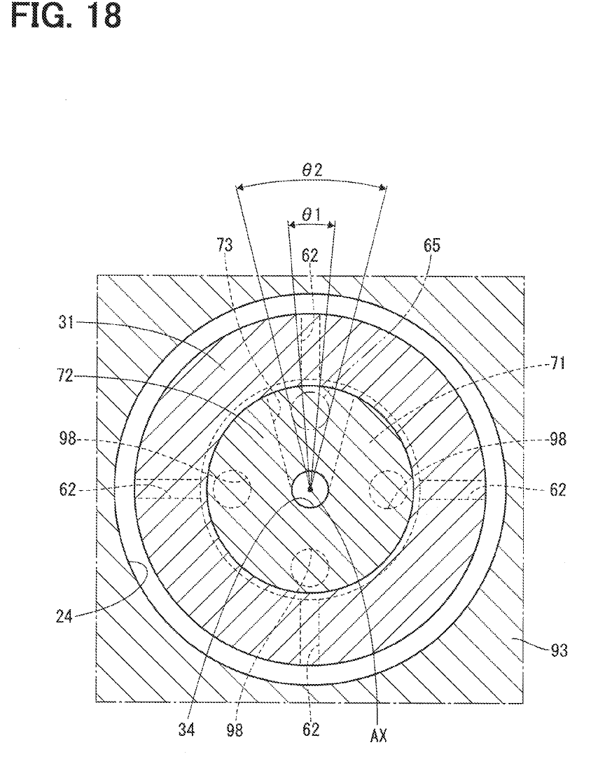

In a ninth embodiment of the present disclosure, as shown in FIGS. 16 to 18, a cover portion 71 is provided. The cover portion 71 closes the injection hole(s) 98, which has been already bored, at a location that is other than the illuminating area of the laser beam. The cover portion 71 is formed integrally with the debris passage portion 72 as a one-piece body and closes the injection hole(s) 98 from the inner wall side of the nozzle body 93. In the present embodiment, the cover portion 71 is formed to project from the debris passage portion 72 in the axial direction and has a cutout 73 in a circumferential part of the cover portion 71, which corresponds to the illuminating area of the laser beam. With this construction, it is possible to limit a decrease in the suction force that would be otherwise caused by introduction of the air from the injection hole(s) 98, which has been already bored, into the debris discharge space 36.

Furthermore, according to the ninth embodiment, the valve seat receiver 31 is rotatable relative to the debris passage portion 72. The debris passage portion 72 is fixed to the second support body 13. The rotatable body 75 includes the supportable portion 22, the workpiece holder 23 and the valve seat receiver 31. The drive device 16 is operable to rotate the rotatable body 75 together with the nozzle body 93 about the axis AX in the state where the valve seat receiver 31 is kept in contact with the valve seat 94. With this construction, the corresponding location of the nozzle body 93, at which the injection hole 98 is bored, can be changed without changing the relative positional relationship between the illuminating area of the laser beam and the cover portion 71.

### Tenth Embodiment

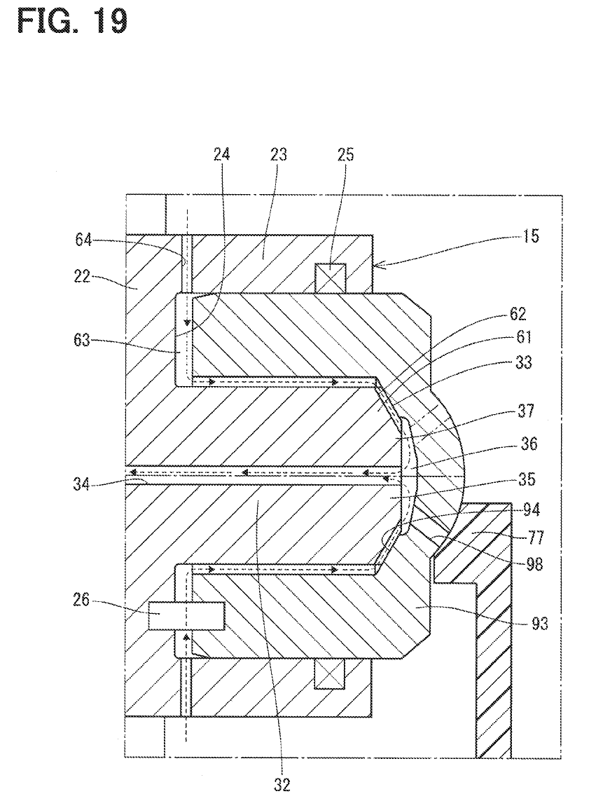

In a tenth embodiment of the present disclosure, as shown in FIG. 19, a cover portion 77 is provided. The cover portion 77 closes the injection hole(s) 98, which has been already bored, at a location that is other than the illuminating area of the laser beam. The cover portion 77 closes the injection hole(s) 98 from the outer wall side of the nozzle body 93. The cover portion 77 is movable by, for example, the second support body 13 (see FIG. 3) in a direction parallel to the axis AX. With this construction, it is possible to limit a decrease in the suction force that would be otherwise caused by introduction of the air from the injection hole(s) 98, which has been already bored, into the debris discharge space 36.

### Reference Embodiment

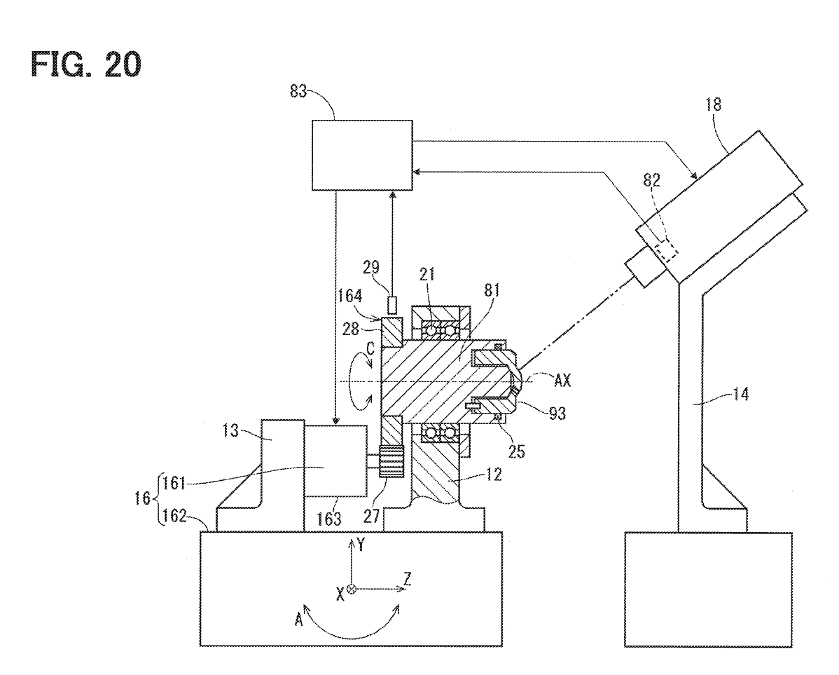

FIG. 20 indicates a reference embodiment. In the reference embodiment, a rotatable body 81 includes the supportable portion 22, the workpiece holder 23 and the valve seat receiver 31. The debris passage and the pump are not provided.

In place of the flow velocity sensor 43 of the first embodiment, a distance sensor 82 is provided. The distance sensor 82 senses a distance between the laser emitter 18 and a laser-illuminated area, which is illuminated with the laser beam outputted from the laser emitter 18, based on a reflected laser beam, which is reflected from the illuminated area.

The distance sensor 82 and the control unit 83 form a penetration sensing device that senses the penetration of the injection hole 98 through the nozzle body 93. Specifically, when the distance, which is sensed with the distance sensor 82, becomes equal to or larger than a predetermined value, the control unit 19 determines that the injection hole 98 penetrates through the nozzle body 93.

The control unit 83 has the functions of the control unit 19 of the first embodiment except the function about the vacuuming. That is, the control unit 83 controls the laser output power of the laser emitter 18 based on the penetration sensing timing. Specifically, the control unit 83 stops the output of the laser beam from the laser emitter 18 when the predetermined first waiting time period elapses from the penetration sensing timing.

### Other Embodiments

In another embodiment of the present disclosure, the penetration sensing device may determine the penetration of the injection hole based on a voltage applied to the pump or an electric current supplied to the pump. Furthermore, the penetration sensing device may determine the penetration of the injection hole based on a measurement of a light-related value of a light sensor that is placed at another location in the debris discharge space, which is other than the illuminating area of the laser beam. That is, it is only required to use a parameter that changes at the time of penetration of the injection hole.

In another embodiment of the present disclosure, the penetration sensing device may be eliminated, and the emitting of the laser beam may be executed only for a predetermined time period. At that time, the laser output power may be kept to be constant throughout the predetermined time period or may be changed with time.

In another embodiment of the present disclosure, the penetration sensing device may be eliminated, and the suctioning may be executed only for a predetermined time period. At that time, the suction force may be kept to be constant throughout the predetermined time period or may be changed with time.

In another embodiment of the present disclosure, the material of the valve seat receiver should not be limited to the metal or the rubber and may, for example, resin.

In another embodiment of the present disclosure, the emitting of the laser beam and the suctioning may not be simultaneously started.

In another embodiment of the present disclosure, the material of the laser receiving part should not be limited to zirconia and may be, for example, ceramic. That is, it is only required that the laser receiving part is made of a material that is harder to be melted by the laser beam in comparison to the metal that forms the nozzle body.

In the first to tenth embodiments, the drive device has five axes as the drive axes. Alternatively, in another embodiment of the present disclosure, the drive device may be a drive device that has drive axes, the number of which is equal to or less than four or equal to or more than six.

In another embodiment of the present disclosure, there may be provided a drive device that can move the laser emitting device relative to the valve seat receiver.

The present disclosure should not be limited to the above embodiments and may be embodied in various other forms without departing from the scope of the present disclosure.

1. A boring device for boring an injection hole in a nozzle body, which has a valve seat formed at an inner wall of the nozzle body, the boring device comprising:
a workpiece holder that holds the nozzle body at a time of boring the injection hole at the nozzle body;
a valve seat receiver that contacts the valve seat of the nozzle body, which is held by the workpiece holder;
a laser emitting device that emits a laser beam to the nozzle body, which is held by the workpiece holder, from a side where an outer wall of the nozzle body is located, to bore the injection hole;
a debris passage portion that is located on a radially inner side of the valve seat receiver, wherein the debris passage portion includes a debris passage that conducts debris, which is generated at the time of boring the injection hole;
a suction device that suctions the debris through the debris passage; and
a control device that controls a laser output power of the laser emitting device and a suction force of the suction device.

2. The boring device according to claim 1, wherein the control device starts suctioning with the suction device before a time of penetrating the injection hole at the nozzle body.

3. The boring device according to claim 1, wherein:
the debris passage portion forms a debris discharge space between the debris passage portion and the nozzle body held by the workpiece holder;
the debris passage is communicated with the debris discharge space; and
the valve seat receiver has an outside communication passage that is communicated with the debris discharge space and is also communicated with an outside space.

4. The boring device according to claim 3, wherein the outside communication passage is a groove that is formed in an opposing part of the valve seat receiver, which is opposed to the valve seat of the nozzle body that is held by the workpiece holder.

5. The boring device according to claim 3, wherein a circumferential angular range, which is occupied by the outside communication passage, overlaps with a circumferential angular range, which is occupied by an illuminating area illuminated with the laser beam of the laser emitting device in the nozzle body.

6. The boring device according to claim 1, further comprising a penetration sensing device, which senses penetration of the injection hole at the nozzle body, wherein the control device controls at least one of the laser output power of the laser emitting device and the suction force of the suction device when the penetration sensing device senses the penetration of the injection hole at the nozzle body.

7. The boring device according to claim 6, wherein when a predetermined first waiting time period elapses from a time of sensing the penetration of the injection hole with the penetration sensing device, the control device reduces the laser output power of the laser emitting device or stops outputting of the laser beam from the laser emitting device.

8. The boring device according to claim 6, wherein:
the control device starts suctioning with the suction device before a time of sensing the penetration of the injection hole with the penetration sensing device;
the control device increases the suction force of the suction device at the time of sensing the penetration of the injection hole with the penetration sensing device; and
the control device decreases the suction force of the suction device or stops the suctioning with the suction device at a time when a predetermined second waiting time period elapses from the time of sensing the penetration of the injection hole with the penetration sensing device.

9. The boring device according to claim 1, wherein the valve seat receiver has a valve seat receiving surface that is in a form of a tapered surface and contacts the valve seat of the nozzle body, which is held by the workpiece holder.

10. The boring device according to claim 1, wherein the valve seat receiver has a valve seat receiving surface that is in a form of a protruding curved surface and contacts the valve seat of the nozzle body, which is held by the workpiece holder.

11. The boring device according to claim 1, further comprising a seal portion that is located between the valve seat of the nozzle body, which is held by the workpiece holder, and the valve seat receiver.

12. The boring device according to claim 1, wherein:
the debris passage portion has a laser receiving part that receives the laser beam, which penetrates through the injection hole, in an inside of the nozzle body; and
a material of at least a part of the valve seat receiver, which contacts the valve seat, is different from a material of the laser receiving part.

13. The boring device according to claim 1, further comprising a cover portion, which covers the injection hole that is already opened in an area that is other than an illuminating area illuminated with the laser beam of the laser emitting device at the nozzle body.

14. The boring device according to claim 13, wherein the cover portion is formed integrally with the debris passage portion and closes the injection hole from a side where the inner wall of the nozzle body is located.

15. The boring device according to claim 13, wherein the cover portion closes the injection hole from the side where the outer wall of the nozzle body is located.

16. The boring device according to claim 1, wherein:
the valve seat receiver is rotatable relative to the laser emitting device; and
the boring device further comprises a drive device that is operable to rotate the valve seat receiver together with the nozzle body about an axis in a state where the valve seat receiver is kept in contact with the valve seat.

17. The boring device according to claim 16, wherein the valve seat receiver is rotatable relative to the debris passage portion.
